(19) United States
(12) Patent Application Publication
(10) Pub. No.: US 2007/0124331 A1
(43) Pub. Date: May 31, 2007

(54) METHOD AND APPARATUS FOR THE SEAMLESS DELIVERY OF CONTENT

(75) Inventor: Jeffrey Jason Griffin, Raleigh, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/164,604

(22) Filed: Nov. 30, 2005

(51) Int. Cl. G06F 17/00; G06F 7/00

(52) U.S. Cl. 707/104.1; 707/100; 715/500.1

(57) ABSTRACT

The system of the invention includes the provision of a bookmark associated with the content file such that the bookmark will save the place in the content file where play back of the content was stopped. The bookmark may be based on a content consumed data comprising total or percentage of elapsed time or data consumed or other measure of consumed data. In one embodiment the bookmark is contained in a separate bookmark file that is created in the user device and associated with the content file. In an alternate embodiment a wrapper is provided as part of the content file where the wrapper includes the bookmark information.

### BACKGROUND

The invention relates generally to the “podcasting” of content and more particularly to a method and apparatus for facilitating the seamless delivery of the content.

“Podcasting” describes the process of distributing content to user devices such as personal computers, portable computers, personal digital assistants, wireless phones, portable digital audio players or other electronic devices capable of receiving, storing and playing back content. Audio and video content files may be distributed via the Internet to a user device that can then digest the content of the downloaded file. The user may subscribe to receive the downloaded content files. The content file may be in the MP3 audio format or any other format. Most user software enables the user to copy the downloaded content file from the user device that originally receives the content, such as a computer, to a second user device, such as a portable digital audio player, such that the content may be consumed on either device.

With current technology, when the content file is copied from a first user device to a second user device, it is copied without any information transmitted from the first user device to the second user device indicating the play back status of the content file. As a result, if the content file is partially consumed on the first user device and then the content file is copied to a second user device, the content must either be displayed from the beginning of the content file or the user must manually attempt to locate the point where the display of the consumption on the first user device was stopped. This may be especially problematic where the content is a recorded program, video or other sequence critical material.

Thus an improved podcast technology that allows the user device to mark the content file for facilitating the later seamless play back of the content file is desired.

### SUMMARY

The system of the invention includes the provision of a bookmark associated with the content file such that the bookmark will save the place in the content file where the consumption of the content was stopped. The bookmark can be used when the user desires to access the same content at a later time either on the same or a different user device. The bookmark may be based on a total or percentage of elapsed time or data consumed. In one embodiment the bookmark is contained in a separate bookmark file may be created in the first user device and associated with the content file. When the content file is transferred to a second user device the bookmark file is also transferred with the content file where it can be accessed by the second user device to allow the second user device to begin consuming the content at the point where play back was stopped on the first user device. In an alternate embodiment a bookmark wrapper is provided as part of the content file where the bookmark information is maintained in the wrapper. When the content file is transferred to a second device, the bookmark wrapper is also transferred as part of that content file.

### BRIEF DESCRIPTION OF THE DRAWINGS

FIG. 1 is a block schematic diagram of a communications system and devices including functionality in accordance with an embodiment of the present invention.

FIGS. 2 and 3 are flow charts illustrating the method of operation of embodiments of the present invention.

### DETAILED DESCRIPTION

The following detailed description of preferred embodiments refers to the accompanying drawings, which illustrate specific embodiments of the invention. Other embodiments having different structures and operations do not depart from the scope of the present invention.

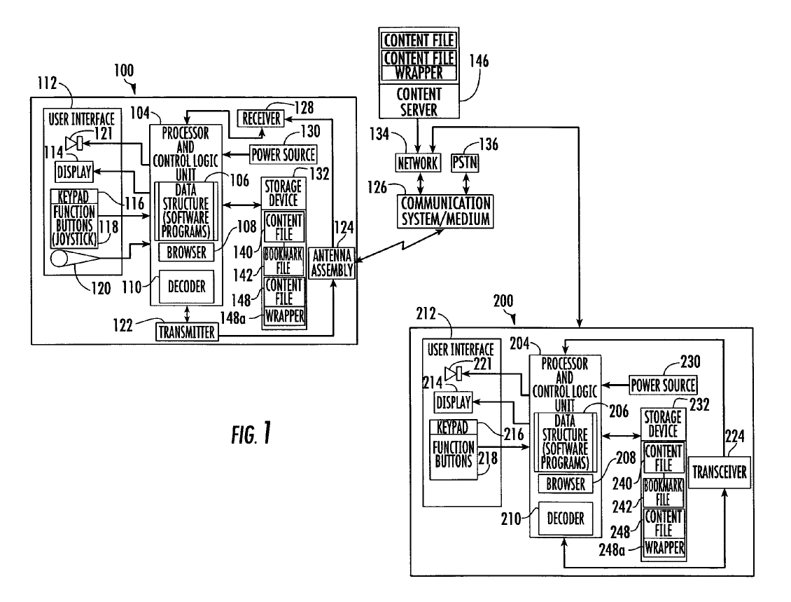

FIG. 1 is a block schematic diagram of an example operating environment of the system of the invention comprising a first user device 100 including functionality in accordance with an embodiment of the present invention. The first user device 100 may comprise a personal computer, portable computer, personal digital assistant, wireless phone, portable digital audio player or other electronic device capable of receiving, storing and playing back a content file. “Play back” and “consume” and variations of these terms as used herein refer to the audio and/or video output of the content of the content file on a user device. The illustrated first user device 100 as described in detail herein is a wireless mobile phone and includes a processor and control logic unit 104. The processor and control logic unit 104 may be a microprocessor or the like. The processor and control logic unit 104 include data structures or software programs 106 including computer-executable or computer-readable instructions to control operation of the communications device 100 and its components. The processor and control logic unit 104 may also include a browser 108.

The first user device 100 may include a user interface 112 to facilitate controlling operation of the first user device 100 including initiating and conducting phone calls and/or other communications. The user interface 112 may include a video monitor or screen 114 to provide a video output and display the content file. The video monitor 114 may be a liquid crystal display (LCD) or the like capable of presenting images. The video monitor 114 provides information to a user or operator in the form of images, text, numerals, characters, a graphical user interface (GUI) and the like. The user interface 112 may also include a keypad 116 and function keys or buttons 118 including a point device, such as a joystick or the like. The function buttons may also comprise soft key pop-up menus. The keypad 116, function buttons and joystick 118 permit the user to communicate commands to the first user device 100 to dial phone numbers, initiate and terminate calls, establish other communications, such as access to the Internet, send and receive email, text messages and the like. The keypad 116, function buttons and joystick 118 may also be used to control the operation of the first user device 100 to enable the functionality of the invention.

The user interface 112 may also include a microphone 120 and a speaker 121. The microphone 120 may receive audio or acoustic signals from a user or from another acoustic source. The microphone 120 converts the audio or acoustic signals to electrical signals. The microphone 120 is connected to the processor and logic unit 104 wherein the processor and logic unit 104 converts the electrical signals to baseband communication signals. The processor and control logic unit 104 is connected to a transmitter 122 that converts baseband signals from the main processor and control logic unit 104 to radio frequency (RF) signals. The transmitter 122 may be connected to an antenna assembly 124 for transmission of the RF signals to a communication medium or system 126.

The antenna assembly 124 receives RF signals over the air and transfers the RF signals to a receiver 128. The, receiver 128 converts the RF signals to baseband signals. The baseband signals are applied to the processor and control logic unit 104 which converts the baseband signals to electrical signals. The processor and control unit 104 may send the electrical signals to speaker 121, which converts the electrical signals to audio signals. The speaker 121 as also used to play back the content file.

A power source 130 is connected to the processor and control logic unit 104 to provide power for operation of the communications device 100. The power source 130 may be a rechargeable battery or the like. The communications device 100 also includes at least one data storage device 132. The data storage device 132 may store the content file 140 downloaded from a content server 146 and the bookmark file 142 created by processor and control logic unit 104 and/or a content file 148 and bookmark wrapper 148a, as will hereinafter be described. Examples of the content server may include a music library, video library, radio program library or the like. The data storage device 132 may be a computer-readable medium to store computer-executable or computer-usable instructions or data structures, such as data structures 106, to perform special operations or functions such as those described in accordance with embodiments of the present invention.

The first user device 100 may be operable in association with a communications system or medium 126 in accordance with an embodiment of the present invention. The communications system or medium 126 may be a mobile, wireless, cellular communications system or similar system. The communications system 126 may couple the first user device 100 to another communication network 134 or to a public switched telephone network 136. The wireless terminal may communicate using any communication standard, such as Advanced Mobile Phone Service (AMPS), Digital Advanced Mobile Phone Service (D-AMPS), Global System for Mobile Communications (GSM), Code Division Multiple Access (CDMA), Time Division Multiple Access (TDMA) or the like. The layout and design illustrated in FIG. 1 is for purposes of explaining the present invention and the present invention is not limited to any particular design. While the first user device 100 illustrated in FIG. 1 is a mobile terminal, the present invention may also be applicable to wired or hard wired communication devices and systems.

A second user device 200 including functionality in accordance with an embodiment of the present invention is also shown and may comprise a personal computer, portable computer, personal digital assistant, wireless phone, portable digital audio player or other electronic devices. The illustrated second user device 200 is described as a computer and may include a processor and control logic unit 204. The processor and control logic unit 204 may be a microprocessor or the like. The processor and control logic unit 204 includes data structures or software programs 206 including computer-executable or computer-readable instructions to control operation of the second user device and its components. The processor and control logic unit 204 may also include a browser 208.

The second user device 200 may include an operator or user interface 212 to facilitate controlling operation of the communications device 200. The user interface 212 may include a video monitor or screen 214 to provide video output and play back the content file. The video monitor 214 may be a liquid crystal display (LCD) or the like capable of presenting images. The display 214 provides information to a user or operator in the form of images, text, numerals, characters, a graphical user interface (GUI) and the like. A speaker 221 is also provided for outputting audio signals including play back of the content file. The user interface 212 may also include a keyboard 216 and function keys or buttons 218 including a point device, such as a mouse or the like. The second user device 200 may also be provided with wireless communication functionality such as provided by a Wi-Fi transceiver 224. The keypad 216, function buttons and mouse 218 are used to control the operation of the communications device 200.

A power source 230 may be connected to the processor and control logic unit 104 to provide power for operation of the device 200. The power source 130 may be a rechargeable battery or the like in the case of a lap top computer or portable digital audio player. The power source may also comprise an external power supply. The second user device 200 also includes at least one data storage device 232. The data storage device 232 may be a computer-readable medium to store computer-executable or computer-usable instructions or data structures, such as data structures 206, to perform special operations or functions such as those described in accordance with embodiments of the present invention. The data storage device 232 may store the content file 240 downloaded from a content server 146 and the bookmark file 242 created by process and control logic unit 204 or received from another user device and/or a content file 248 and bookmark wrapper 248a as will hereinafter be described.

The device 200 may be operable in association with communication network 134 or to a public switched telephone network 136 via a wireless connection, cable modem, dial-up connection or the like. While user devices 100 and 200 have been described with respect to the embodiments disclosed herein it is to be understood that the user devices could have other configurations.

In one embodiment each of the user devices 100 and 200 that operate the system of the invention include decoders 110 and 210, respectively, that are capable of receiving and decoding the standard format of the content file, such as MP3, received from the content server to produce an uncompressed output of audio and/or video that can be played back to the user on a video screen or via speakers or the like. The decoders act on the content files 140, 240, 148 and 248.

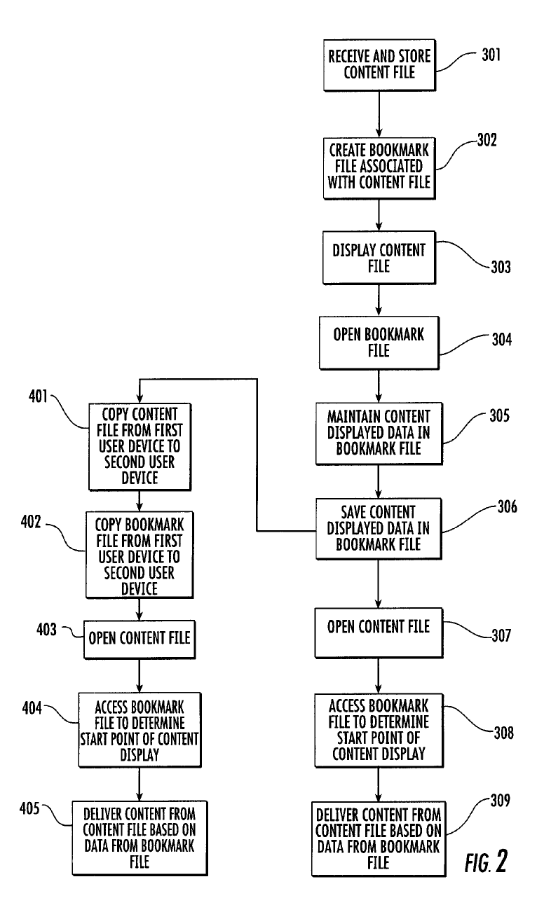

Referring to FIG. 2, when the user desires to obtain podcast content, a content file is transmitted from the content server 146 to the first user device 100 over network 134 and/or communications system 126. The transmission of the content file may be initiated by the user or may automatically initiated such as through a subscription service. The downloaded content file 140 is received and stored in data storage 132 (block 301). A separate bookmark file 142 is created that is associated with that particular content file (block 302). In one embodiment the bookmark file may be created by the first user device upon receipt of the content file. Alternatively, the bookmark file may be created by the server 146 and downloaded to the first user device 100 as a separate file when the content file is downloaded. Where more than one content file is saved in data storage 132, each of the content files will have a separate bookmark file created and associated therewith. When the content in the content file 140 is consumed (block 303) the bookmark file 142 is accessed (block 304) and a record of the content consumed is maintained in the bookmark file 142 (block 305). The amount of content consumed by the user device is referred to herein as content consumed data. The content consumed data can be maintained as a running time in for example minutes and seconds, a data consumed tally in for example the number of bytes consumed or a percentage of running time or data consumed or other measure of content consumed. The bookmark file 142 captures and saves this content consumed data to create a record of the content consumed (block 306). The bookmark file 142 may save the content consumed data when the user closes the content file or it may save the data automatically, for example, the bookmark file may be updated every minute. When the content file 140 is reopened (block 307) the associated bookmark file 142 is automatically accessed. The bookmark file 142 is accessed by the system to determine where in the content file play back of content should begin (block 308). The processor and control logic unit determines the time elapsed or data consumed as stored in the bookmark file 142 and initiates the next session at the first undisplayed byte after the last displayed byte. Content is delivered from the content file 140 starting at the point indicated in the bookmark file 142 (block 309). Thus, the system can immediately begin seamless play back of the content to the user in the second session from the point where the first session was terminated. A user control function may also be provided such as by providing a user cuing input on interface 112 such as fast forward/rewind/restart to allow manual control of the content.

The system of the invention has particular applicability where the content file is copied and transferred from a first user device to a second user device after consuming a portion of the content on the first user device. For example, the user may initiate the podcast to mobile terminal 100 where content from a content provider 146 is transmitted to the first user device 100 via network 134 and communications system 126. The first user device 100 saves the content file 140 in data storage 132 and creates a bookmark file 142 associated with the content file 140 as previously described (blocks 301 and 302). When the first user device consumes the content from the content file 140, the bookmark file 142 captures and saves the content consumed data as previously described (blocks 303 through 306).

When the user wants to transfer the content from the first user device 100 to a second user device 200, the user copies the content file 140 from the first user device to the second user device to create a second content file 240 (block 401). When the content file is copied, the bookmark file 142 is also copied from the first user device to the second user device to create a second bookmark file 242 (block 402). When the content file 240 is subsequently opened on the second user device 200 (block 403), the bookmark file 242 is accessed and the saved content consumed data is retrieved to identify where in the content file 240 the last session stopped play back of the content (block 404). The second device 200 automatically initiates play back of the content from content file 240 from the point identified in the bookmark file 242 (block 405) such that the play back of content can seamlessly continue without the need to manually locate a desired starting point and without having more or less content consumed and displayed than is necessary.

Use of a separate bookmark file is useful where a standardized format does not exist for the content file that provides the bookmark functionality as part of the content file. Because the content files are standardized to allow their use between and across different manufacturers' equipment, the format of the content file cannot be changed absent industry wide acceptance. The use of a separate bookmark file avoids this problem because the bookmark file does not alter the standard format of the content file. For the equipment that recognizes the bookmark file, the system will operate as described above. For equipment that does not recognize the bookmark file, the content file can still be displayed but the bookmark functionality of the invention is not available.

One mechanism for providing a standardized method for transferring the bookmark information without using a separate file would be to create a metadata wrapper or tag similar to the DRM (Digital Rights Management) wrapper currently used with MP3 files to transfer encryption and header information such as title of content, artist identification or the like. Alternatively a portion of an existing wrapper could be used to carry the display data. It will be appreciated that content formats such as MP3 are standardized such that any properly configured user device can receive, decode and display any data received in that format irrespective of source. Thus, it is important that any metadata not corrupt or interfere with the standardized data formats. Thus wrappers or tags are used that are part of the content file but that do not interfere with the standardized content format.

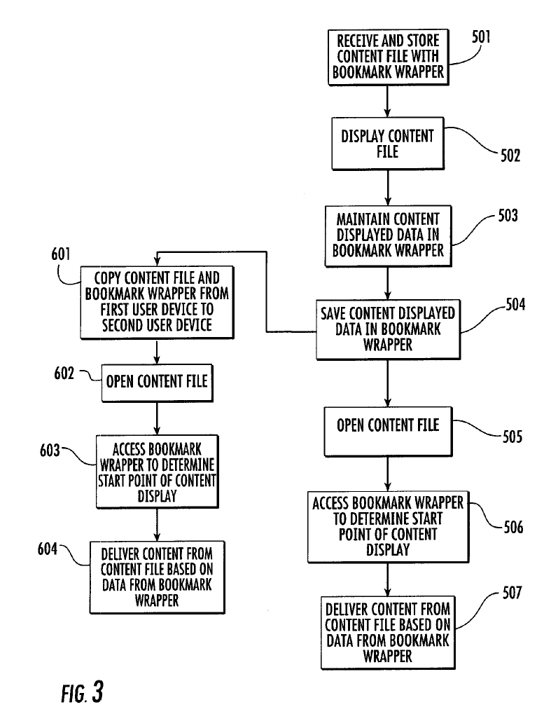

Referring to FIG. 3, the content file with a bookmark wrapper is transmitted from the content server 146 to the user device 100. When the content file 148 is received at the user device, the bookmark wrapper 148a is also received as part of that content file (block 501). The content file 148 including bookmark wrapper 148a are stored in storage device 132 (block 501). When the content file is consumed (block 502) a record of the content consumed data is maintained in the bookmark wrapper 148a (block 503). The amount of content consumed data can be maintained as a running time in for example minutes and seconds, a data consumed tally in for example the number of bytes consumed or a percentage of running time or data consumed or other measure of content consumed. The bookmark wrapper 148a captures and saves this data to create a record of the content consumed (block 504). The bookmark wrapper 148a may save the content consumed data when the user closes the content file or it may save the data automatically, for example, the bookmark file may be updated every minute.

When the content file 148 is again opened (block 505) the content consumed data is accessed from the bookmark wrapper 148a (block 506). The processor and control logic unit determines the time elapsed or data consumed as stored in the wrapper and initiates the next session at the first unconsumed byte after the last consumed byte to display the content from the point indicated in the bookmark wrapper 148a (block 507). Thus, the system can immediately begin play back of the content to the user in the second session from the point where the first session was terminated. A user control function may also be provided such as by providing a user cuing input on interface 112 such as fast forward/rewind/restart to allow manual control of the content.

The use of the wrapper also has applicability where the content file is copied and transferred from a first device to a second device after consuming a portion of the content on the first user device as previously described. The content consumed data saved in the bookmark wrapper 148a may be the same as the content consumed data collected in the separate bookmark file 142 and may be used in the same manner to allow a user to bookmark a location in the content file. However, a separate data file would not have to maintained, copied and transferred.

When the user wants to transfer the content from the first user device 100 to a second user device 200, the user copies the content file 148 and wrapper 148a from the first user device to the second user device to create a second content file 248 with bookmark wrapper 248a (block 601). When the content file 248 is subsequently opened on the second user device 200 (block 602), the bookmark wrapper 248a is accessed and the saved content consumed data is retrieved to identify where in the content file 248 the last session stopped consuming content (block 603). The second device 200 automatically initiates play back of the content from content file 248 from the point identified in the bookmark wrapper 248a (block 604) such that the play back of content can seamlessly continue without the need to manually locate a desired starting point and without having more or less content consumed than is necessary.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A file bookmarking apparatus comprising:
a first file containing content said content being in a standard first format;
a second file associated with the first file containing a bookmark for the first file said bookmark containing a record of consumed data and being in a second format different than said standard first format; and
means for consuming the content from the first file based on the bookmark in the second file.

2. (canceled)

3. The apparatus of claim 1 wherein the standard first format is MP3.

4. The apparatus of claim 1 wherein the consumed data includes elapsed time.

5. (canceled)

6. (canceled)

7. (canceled)

8. (canceled)

9. (canceled)

10. (canceled)

11. A method for bookmarking a content file comprising:
receiving a content file in a first user device said content file being in a standard first format;
creating a bookmark file associated with the content file said bookmark file containing a record of consumed data and being in a second format different than said standard first format; and
storing said consumed data in the bookmark file.

12. The method of claim 11 wherein the consumed data includes elapsed time.

13. The method of claim 11 wherein the consumed data includes data consumed.

14. The method of claim 11 wherein the consumed data includes a percentage of elapsed time.

15. The method of claim 11 wherein the consumed data includes a percentage of data consumed.

16. The method of claim 11 sending the content file and bookmark file to a second user device.

17. The method of claim 16 using the bookmark file at the second user device to determine where to start play back of the content file.

18. (canceled)

19. (canceled)

20. (canceled)

21. The apparatus of claim 1 wherein the consumed data includes data consumed.

22. The apparatus of claim 1 wherein the consumed data includes a percentage of elapsed time.

23. The apparatus of claim 1 wherein the consumed data includes a percentage of data consumed.

24. A file bookmarking apparatus comprising:
a first file containing content said content being in a standard first format;
a second file associated with the first file containing a bookmark for the first file said bookmark contains a record of consumed data and being in a second format different than said standard first format; and
a processor and control logic for consuming the content from the first file based on the bookmark in the second file.
